(19) United States
(12) Patent Application Publication
(10) Pub. No.: US 2008/0088285 A1
(43) Pub. Date: Apr. 17, 2008

(54) Voltage stabilizing circuit with constant current circuit

(75) Inventors: Tong Zhou, Shenzhen (CN); Jia-Hui Tu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOCOM TECHNOLOGY (SHENZHEN) CO., LTD.; INNOLUX DISPLAY CORP.

(21) Appl. No.: 11/974,126

(22) Filed: Oct. 11, 2007

(30) Foreign Application Priority Data
Oct. 11, 2006 (TW) 95137311

(51) Int. Cl. G05F 1/44; G05F 1/10

(52) U.S. Cl. 323/271; 323/282

(57) ABSTRACT

An exemplary voltage stabilizing circuit (2) includes a voltage input port (20), a voltage output port (21), a first transistor (22), a constant current circuit (23), and a feedback control circuit (24). The first transistor has a first base (221), a first emitter (222) connected to the output port, and a first collector (223) connected to the input port. The feedback control circuit has a resistor (244), a branch circuit (245-247), a voltage stabilizing unit (242), and a second transistor (241). The second transistor has a second emitter (2412) connected to ground via the voltage stabilizing unit and connected to the output port, a second collector (2413) connected to the first base of the first transistor, and a second base (2411) connected to the branch circuit. The constant current circuit provides current to the first base of the first transistor and the second collector of the second transistor.

### BACKGROUND OF THE INVENTION

1. Field of the Invention

The present invention relates to a voltage stabilizing circuit, and particularly to a voltage stabilizing circuit typically used in a liquid crystal panel of a liquid crystal display.

2. General Background

In general, a liquid crystal display needs various voltage levels for different parts of electronic circuits therein. Thus a liquid crystal display includes a voltage stabilizing circuit that provides a stable power supply to different parts of the electronic circuits therein. The voltage stabilizing circuit has become an important component in a modem liquid crystal display.

Referring to FIG. 3, this is a diagram of a conventional voltage stabilizing circuit. The voltage stabilizing circuit 1 includes a direct current voltage input port 10, a direct current voltage output port 11, a bipolar NPN (negative-positive-negative) transistor 12, an operational amplifier 13, a stabilizing diode 14, a current limiting resistor 15, and a series arrangement of a resistor 161, an adjustable resistor 162, and a resistor 163.

The operational amplifier 13 includes a non-inverting input 131, an inverting input 132, and an output 133. The non-inverting input 131 is connected to a cathode of the stabilizing diode 14, an anode of the stabilizing diode 14, and thence to ground in that sequence. The non-inverting input 131 is also connected to the direct current voltage input port 10 through the current limiting resistor 15. The inverting input 132 is connected to the adjustable resistor 162, the resistor 163, and thence to ground in that sequence. Further, the inverting input 132 is connected to the direct current output voltage port 11 via the resistor 161. The output 133 is connected to a base 121 of the bipolar NPN transistor 12. Furthermore, an emitter 122 of the bipolar NPN transistor 12 is connected to the direct current voltage output port 11, and a collector 123 of the bipolar NPN transistor 12 is connected to the direct current voltage input port 10.

Operation of the voltage stabilizing circuit 1 is as follows:

When a load (not shown) decreases, a voltage of the direct current voltage output port 11 is lowered, and a voltage of the inverting input 132 of the operational amplifier 13 is lowered. However, a voltage of the non-inverting input 131 is kept steady due to the function of the stabilizing diode 14. Accordingly, the potential difference between the non-inverting input 131 and the inverting input 132 is increased, the voltage of the output 133 of the operational amplifier 13 is raised, a current passing across the base 121 of the bipolar NPN transistor 12 can be increased, the potential difference between the collector 123 and the emitter 122 of the bipolar NPN transistor 12 is decreased, and the voltage of the direct current voltage output port 11 can be raised.

When the load (not shown) increases, a voltage of the direct current voltage output port 11 is raised, and a voltage of the inverting input 132 of the operational amplifier 13 is raised. However, the voltage of the non-inverting input 131 is kept steady due to the function of the stabilizing diode 14. Accordingly, the potential difference between the non-inverting input 131 and the inverting input 132 is decreased, the voltage of the output 133 of the operational amplifier 13 is lowered, a current passing across the base 121 of the bipolar NPN transistor 12 can be decreased, the potential difference between the collector 123 and the emitter 122 of the bipolar NPN transistor 12 is increased, and the voltage of the direct current voltage output port 11 can be lowered.

When the operational amplifier 13 and the bipolar NPN transistor 12 are regarded as an amplifier circuit (not labeled), a gain A of the amplifier circuit is calculated by the following equation (1):

$$A = \frac{{U}_{o}}{{U}_{a} - {U}_{b}} = \frac{{U}_{o}}{{U}_{r} - {U}_{b}} \qquad ( 1 )$$

wherein Uₒ is the voltage of the direct current voltage output port 11, Uₐ is the voltage of the non-inverting input 131, Uᵣ is the stabilizing voltage of the stabilizing diode 14, and U_{b} is the voltage of the inverting input 132.

When the series arrangement of the resistor 161, the adjustable resistor 162, and the resistor 163 is regarded as a feedback circuit (not labeled), a feedback coefficient F of the feedback circuit is calculated by the following equation (2):

$$F = \frac{{U}_{b}}{{U}_{o}} = \frac{{R}_{2} + {R}_{3}}{{R}_{1} + {R}_{2} + {R}_{3}} \qquad ( 2 )$$

wherein R₁ is the resistance of the resistor 161, R₂ is the resistance of the adjustable resistor 162, and R₃ is the resistance of the resistor 163. According to equation (1) and equation (2), the following equation (3) is derived:

$${U}_{o} = \frac{{AU}_{r}}{1 + AF} \qquad ( 3 )$$

### As the gain A is very large, the voltage Uₒ of the direct current voltage output port 11 can be calculated by the following equation (4):

$${U}_{o} \approx \frac{I}{F} {U}_{r} \approx \frac{{U}_{r} ( {R}_{1} + {R}_{2} + {R}_{3} )}{{R}_{2} + {R}_{3}} \approx {U}_{r} ( 1 + \frac{{R}_{1}}{{R}_{2} + {R}_{3}} ) \qquad ( 4 )$$

In general, the stabilizing voltage Uᵣ of the stabilizing diode 14 is chosen in advance. Thus, as the gain A is very large, the direct current voltage output port 11 can output a desired value of the voltage Uₒ by setting the values of the resistances of the resistor 161, the adjustable resistor 162, and the resistor 163. On the other hand, either the voltage of the direct current voltage output port 11 or the gain A is usually not high enough to be able to calculate accurately the voltage Uₒ outputted from the voltage stabilizing circuit 1 by using equation (4). In the other words, setting the values of the resistances of the resistor 161, the adjustable resistor 162, and the resistor 163 does not necessarily make the direct current voltage output port 11 of the voltage stabilizing circuit 1 accurately output the required voltage. Thus, the output voltage of the voltage stabilizing circuit 1 is liable to be imprecise.

### SUMMARY

In one aspect, a voltage stabilizing circuit includes a voltage input port, a voltage output port, a first transistor, a constant current circuit, and a feedback control circuit. A first emitter of the first transistor is connected to the voltage output port. A first collector of the first transistor is connected to the voltage input port. The feedback control circuit includes a first resistor, a branch circuit, a voltage stabilization unit, and a second transistor. One port of the branch circuit is grounded, and another port of the branch circuit is connected to the voltage output port. The branch circuit includes a second resistor and an adjustable resistor. A base of the second transistor is connected between the second resistor and the adjustable resistor. An emitter of the second transistor is configured to be connected to ground via the voltage stabilization unit. Further, the emitter of the second transistor is also connected to the voltage output port via the first resistor. A collector of the second transistor is connected to the base of the first transistor. The constant current circuit is configured to provide current to the emitter of the first transistor and the collector of the second transistor.

In addition, the constant current circuit includes a third resistor, a first diode, a second diode, a resistance-capacitance (RC) parallel circuit, and a third transistor, and the third transistor. The third transistor has a base configured to be connected to ground via the RC parallel circuit and also connected to the voltage input port via the first diode and the second diode, an emitter connected to the voltage input port via the first resistor, and a collector connected to the base of the first transistor.

Furthermore, at least one capacitor unit is configured to be connected between ground and the voltage ports for filtering interference (signal noise). Except that, the capacitor unit includes at least one electrolytic capacitor and at least one film capacitor.

In another aspect, a voltage stabilizing circuit includes a voltage input port, a voltage output port, an N-channel metal-oxide-semiconductor field-effect transistor (N-MOSFET) provided as a first transistor, a feedback control circuit, and a constant current circuit. The first transistor has a gate, a source connected to the voltage output port, and a drain connected to the voltage input port. The feedback control circuit has a first resistor, a branch circuit, a voltage stabilizing unit, and a second transistor. The second transistor has an emitter configured to be connected to ground via the voltage stabilizing unit and connected to the voltage output port, a collector connected to the gate of the first transistor, and a base connected to the branch circuit. The constant current circuit is configured to provide current to the gate of the first transistor and the collector of the second transistor.

In the other aspect, a voltage stabilizing circuit includes a voltage input port, a voltage output port, a first capacitor unit, a first transistor, a constant current circuit, a feedback control circuit, and a second capacitor unit. The first capacitor unit configured to be connected between ground and the voltage input port, and the second capacitor unit configured to be connected between ground and the voltage output port. The first transistor having a first electrode connected to the voltage output port, a second electrode connected to the voltage input port, and a third electrode. The feedback control circuit having a first resistor, a branch circuit, a voltage stabilizing unit, and a second transistor, wherein the second transistor has an emitter configured to be connected to ground via the voltage stabilizing unit and connected to the voltage output port, a collector connected to the third electrode of the first transistor, and a base connected to the branch circuit. The constant current circuit configured to be provide current to the third electrode of the first transistor and the collector of the second transistor.

### BRIEF DESCRIPTION OF THE DRAWINGS

Embodiments of the present invention can be more fully understood by reading the subsequent detailed description and examples with references made to the accompanying drawings, wherein:

FIG. 1 is a diagram of a voltage stabilizing circuit according to a first exemplary embodiment of the present invention;

FIG. 2 is a diagram of a voltage stabilizing circuit according to a second exemplary embodiment of the present invention; and

FIG. 3 is a diagram of a conventional voltage. stabilizing circuit.

### DETAILED DESCRIPTION

Hereinafter, preferred and exemplary embodiments of the present invention will be described with the reference to the attached drawings.

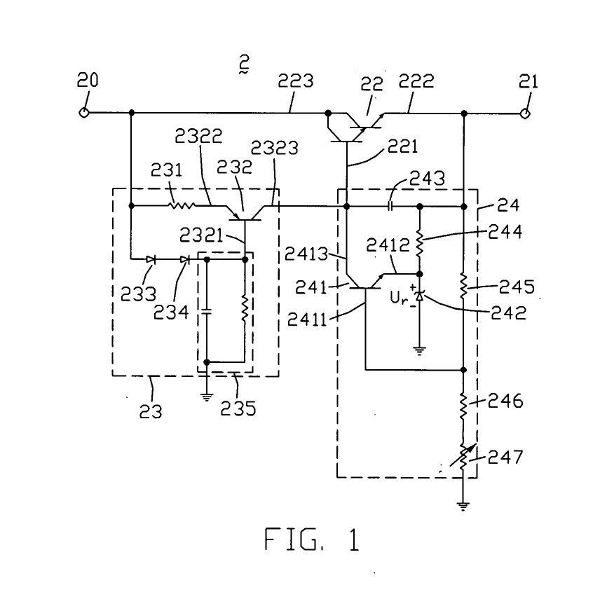

FIG. 1 is a diagram of a voltage stabilizing circuit 2 according to a first exemplary embodiment of the present invention. The voltage stabilizing circuit 2 includes a voltage input port 20, a voltage output port 21, a first transistor 22, a constant current circuit 23, and a feedback control circuit 24.

Typically, the first transistor 22 is an NPN type transistor. The first transistor 22 has an emitter 222 connected to the voltage output port 21, a collector 223 connected to the voltage input port 20, and a base 221 connected to the constant current circuit 23.

The constant current circuit 23 includes a first resistor 231, a second transistor 232, a first diode 233, a second diode 234, and an RC (resistance-capacitance) parallel circuit 235. The first resistor 231 is used to limit current passing to the second transistor 232. The first diode 233 and the second diode 234 are used to produce a voltage drop to enable the second transistor 232 to form a constant current source. Furthermore, the value of the constant current is dependent on a resistor (not labeled) of the RC parallel circuit 235, and on a capacitor (not labeled) of the RC parallel circuit 235. The capacitor (not labeled) is configured to filter high frequency interference.

Typically, the second transistor 232 is a bipolar PNP (positive-negative-positive) type transistor. The second transistor 232 has a base 2321 connected to ground via the RC parallel circuit 235, an emitter 2322 connected to the voltage input port 20 through-the first resistor 231, and a collector 2323 connected to the base 221 of the first transistor 22. Furthermore, the base 2321 is also connected to the voltage input port 20 via a cathode (not labeled) and an anode (not labeled) of the second diode 234 and a cathode (not labeled) and an anode (not labeled) of the first diode 233.

The feedback control circuit 24 includes a third transistor 241, a voltage stabilizing diode 242, a capacitor 243, a second resistor 244, and a branch circuit (not labeled) with a series connection of resistors, such as a third resistor 245, a fourth resistor 246, and an adjustable resistor 247, as shown in FIG. 1.

Typically, the third transistor 241 is an NPN type transistor. The third transistor 241 has a base 2411 connected to the voltage output port 21 via the third resistor 245, an emitter 2412 connected to the voltage output port 21 via the second resistor 244, and a collector 2413 connected to the base 221 of the first transistor 22.

The operational principle of the voltage stabilizing circuit 2 is as follows:

A voltage of the voltage output port 21 is raised when a load (not shown) increases. Therefore a voltage of the base 2411 of the third transistor 241 is raised, and a current passing across the base 2411 of the third transistor 241 is also raised. Thereby a current of the collector 2413 of the third transistor 241 is lowered. A current from the collector 2323 of the second transistor 232 passes to the base 221 of the first transistor 22 and the collector 2413 of the third transistor 241, so that a current passing across the base 221 of the first transistor 22 is raised as the current passing to the collector 2413 of the third transistor 241 is lowered. Accordingly, the potential difference between the collector 223 and the emitter 222 of the first transistor 22 is increased, and the voltage of the voltage output port 21 can be decreased.

A voltage of the voltage output port 21 is lowered when the load (not shown) decreases. Therefore a voltage of the base 2411 of the third transistor 241 is lowered, and a current passing across the base 2411 of the third transistor 241 is also lowered. Thereby a current of the collector 2413 of the third transistor 241 is raised. A current from the collector 2323 of the second transistor 232 passes to the base 221 of the first transistor 22 and the collector 2413 of the third transistor 241, so that a current passing across the base 221 of the first transistor 22 is lowered as the current passing to the collector 2413 of the third transistor 241 is raised. Accordingly, the potential difference between the collector 223 and the emitter 222 of the first transistor 22 is decreased, and the voltage of the voltage output port 21 can be increased.

In other words, the first transistor 22 functions as an adjustable power (voltage or current) unit. Furthermore, the capacitor 243 is used to improve the circuit efficiency. The second resistor 244 is used to keep a voltage of the voltage stabilizing diode 242 stable.

The voltage Uₒ of the voltage output port 21 is represented by the following equation (5):

Uₒ=I(R₃+R₄+Rₓ) (5)

wherein R₃ is the resistance of the third resistor 245, R₄ is the resistance of the fourth resistor 246, and Rₓ is the resistance of the adjustable resistor 247. I is the current passing the third resistor 245, the fourth resistor 246 and the adjustable resistor 247, and is calculated by the following equation (6):

$$I = \frac{{V}_{b}}{{R}_{4} + {R}_{X}} = \frac{{V}_{r} + {V}_{bc}}{{R}_{4} + {R}_{X}} = \frac{{V}_{r} + 0.7 V}{{R}_{4} + {R}_{X}} \qquad ( 6 )$$

wherein V_{b} is the voltage of the base 2411 of the third transistor 241, Vᵣ is the stabilizing voltage of the voltage stabilizing diode 242, and V_{be} is the potential difference between the base 2411 and the emitter 2412 of the third transistor 241. In this example, a predetermined value of V_{be} is 0.7 volts.

In general, the stabilizing voltage Uᵣ of the voltage stabilizing diode 242 is chosen in advance. Accordingly; the voltage of the voltage output port 21 can be accurately calculated by setting the resistance values of R₃, R₄, and Rₓ of the third resistor 245, the fourth resistor 246 and the adjustable resistor 247 respectively. Thus, the output voltage of the voltage stabilizing circuit 2 is precise, and can conform to a desired predetermined value.

In addition, the voltage input port 20 is a direct current (DC) voltage input port, and the voltage output port 21 is a DC voltage output port.

Furthermore, the first transistor 22 can be an NPN Darlington transistor, as shown in FIG. 1. In such case, there are at least two bipolar transistors combined in a single device. Thus, the current can be amplified by the first bipolar transistor, and amplified further by the second bipolar transistor, so that the gain of the first transistor 22 can be higher. On the other hand, the potential difference V_{be} between the base 221 and the emitter 222 also can be almost twice of that of a standard NPN transistor.

Moreover, the voltage stabilizing diode 242 can be a zener diode.

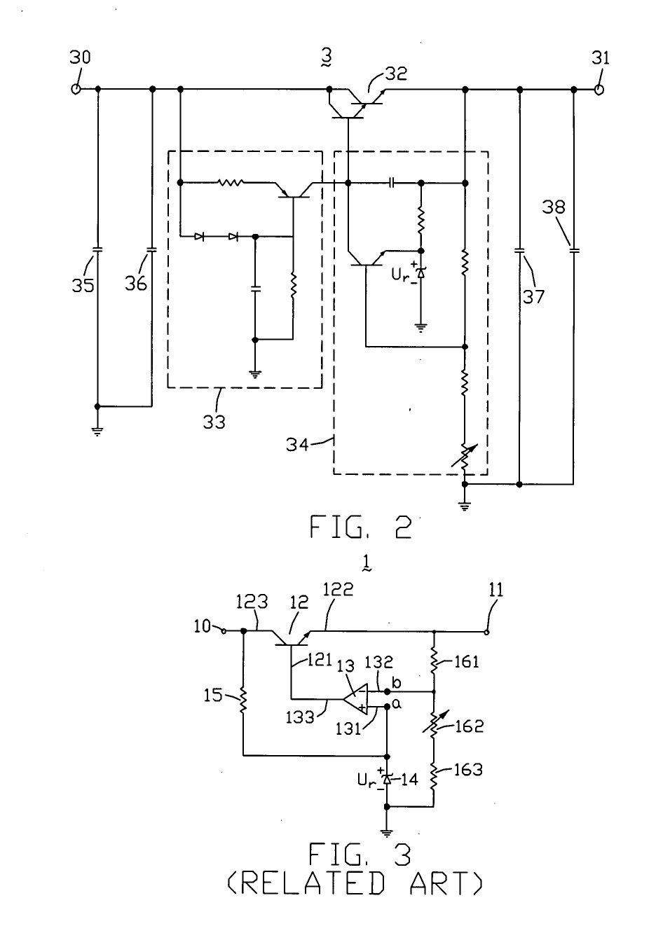

Referring to FIG. 2, this is a diagram of a voltage stabilizing circuit 3 according to a second exemplary embodiment of the present invention. The voltage stabilizing circuit 3 is substantially the same as the voltage stabilizing circuit 2, and includes a voltage input port 30, a first transistor 32, a constant current circuit 33, and a feedback control circuit 34. The difference between the voltage stabilizing circuit 3 and the voltage stabilizing circuit 2 is that the voltage stabilizing circuit 3 further includes a first electrolytic capacitor 35, a second electrolytic capacitor 37, a first film capacitor 36, and a second film capacitor 38. One terminal of each of the first electrolytic capacitor 35 and the first film capacitor 36 is connected to ground. The other terminal of each of the first electrolytic capacitor 35 and the first film capacitor 36 is connected to the voltage input port 30. The first electrolytic capacitor 35 is used not only to store power (such as a voltage or a current) inputted from the voltage input port 30, but also to filter low frequency interference and noise. The first film capacitor 36 is used to filter high frequency interference and noise. Thus, the inputted power can be substantially absolute. One terminal of each of the second electrolytic capacitor 37 and the second film capacitor 38 is connected to ground. The other terminal of each of the second electrolytic capacitor 37 and the second film capacitor 38 is connected to the voltage output port 31. The output power (such as the output voltage Uₒ or an output current) can be treated by the second electrolytic capacitor 37, which stores the output power and filters low frequency interference therefrom. In addition, high frequency interference is also filtered out from the output power by the second film capacitor 38. Thus, substantially absolute output power (such as the output voltage Uₒ or an output current) can be provided from the voltage output port 31.

In addition, the voltage input port 30 is a DC voltage input port, and the voltage output port 31 is a DC voltage output port.

Furthermore, each of the above-described voltage stabilizing circuits 2, 3 can have various alternative configurations. For example, the voltage stabilizing diode 242 of the feedback control circuit 24 of the voltage stabilizing circuit 2 can be a unit with a suitable stabilizing function. In another example, the first transistor 22 can be an N-channel Metal-Oxide-Semiconductor Field-Effect Transistor (N-MOSFET). In such case, a gate of the N-MOSFET is connected to the collector 2323 of the second transistor 232, a source of the N-MOSFET is connected to the voltage output port 21, and the drain of the N-MOSFET is connected to the voltage input port 20.

Moreover, the above-described voltage stabilizing circuits 2, 3 relate to power supply systems in general, and more specifically to power supply systems providing precise and stable power under a load. The voltage stabilizing circuits 2, 3 are particularly well suited for use in or with a liquid crystal display panel power supply, among other applications.

While the above description has been by way of examples and in terms of one or more preferred embodiments, it is to be understood that the invention is not limited thereto. To the contrary, the above description is intended to cover various modifications and similar arrangements, including as would be apparent to those skilled in the art. Therefore, the scope of the appended claims should be accorded the broadest interpretation so as to encompass all such modifications and similar arrangements.

We claim:

1. A voltage stabilizing circuit comprising:
a voltage input port;
a voltage output port;
a first transistor having a first base, a first emitter connected to the voltage output port, and a first collector connected to the voltage input port;
a feedback control circuit having a first resistor, a branch circuit, a voltage stabilizing unit, and a second transistor, wherein the second transistor has a second emitter configured to be connected to ground via the voltage stabilizing unit and connected to the voltage output port, a second collector connected to the first base of the first transistor, and a second base connected to the branch circuit; and
a constant current circuit configured to provide current to the first base of the first transistor and the second collector of the second transistor.

2. The voltage stabilizing circuit in accordance with claim 1, wherein the branch circuit is connected between the voltage output port and ground.

3. The voltage stabilizing circuit in accordance with claim 1, wherein the branch circuit comprises a second resistor and an adjustable resistor, and the second base of the second transistor is connected between the second resistor and the adjustable resistor.

4. The voltage stabilizing circuit in accordance with claim 1, wherein the constant current circuit comprises a third resistor, a first diode, a second diode, a resistance-capacitance (RC) parallel circuit, and a third transistor, and the third transistor has a third base configured to be connected to ground via the RC parallel circuit and connected to the voltage input port via the first diode and the second diode, a third emitter connected to the voltage input port via the first resistor, and a third collector connected to the first base of the first transistor.

5. The voltage stabilizing circuit in accordance with claim 4, wherein the third transistor is a positive-negative-positive (PNP) type transistor.

6. The voltage stabilizing circuit in accordance with claim 1, further comprising a first electrolytic capacitor configured to be connected between ground and the voltage input port.

7. The voltage stabilizing circuit in accordance with claim 6, further comprising a first film capacitor configured to be connected between ground and the voltage input port.

8. The voltage stabilizing circuit in accordance with claim 1, further comprising a second electrolytic capacitor configured to be connected between ground and the voltage output port.

9. The voltage stabilizing circuit in accordance with claim 8, further comprising a second film capacitor configured to be connected between ground and the voltage output port.

10. The voltage stabilizing circuit in accordance with claim 1, further comprising a capacitor connected between the first base of the first transistor and the voltage output port.

11. The voltage stabilizing circuit in accordance with claim 1, wherein the voltage input port is a direct current voltage input port and the voltage output port is a direct current voltage output port.

12. The voltage stabilizing circuit in accordance with claim 1, wherein the voltage stabilizing unit is a stabilizing diode.

13. The voltage stabilizing circuit in accordance with claim 1, wherein the second transistor is a negative-positive-negative (NPN) type transistor.

14. The voltage stabilizing circuit in accordance with claim 13, wherein the first transistor is one of an NPN type transistor and an N-channel Metal-Oxide-Semiconductor Field-Effect Transistor (N-MOSFET).

15. A voltage stabilizing circuit comprising:
a voltage input port;
a voltage output port;
an N-channel metal-oxide-semiconductor field-effect transistor provided as a first transistor, wherein the first transistor has a gate, a source connected to the voltage output port, and a drain connected to the voltage input port;
a feedback control circuit having a first resistor, a branch circuit, a voltage stabilizing unit, and a second transistor, wherein the second transistor has an emitter configured to be connected to ground via the voltage stabilizing unit and connected to the voltage output port, a collector connected to the gate of the first transistor, and a base connected to the branch circuit; and
a constant current circuit configured to provide current to the gate of the first transistor and the collector of the second transistor.

16. A voltage stabilizing circuit comprising:
a voltage input port;
a voltage output port;
a first capacitor unit configured to be connected between ground and the voltage input port;
a first transistor having a first electrode connected to the voltage output port, a second electrode connected to the voltage input port, and a third electrode;
a feedback control circuit having a first resistor, a branch circuit, a voltage stabilizing unit, and a second transistor, wherein the second transistor has an emitter configured to be connected to ground via the voltage stabilizing unit and connected to the voltage output port, a collector connected to the third electrode of the first transistor, and a base connected to the branch circuit;
a constant current circuit configured to be provide current to the third electrode of the first transistor and the collector of the second transistor; and
a second capacitor unit configured to be connected between ground and the voltage output port.

17. The voltage stabilizing circuit in accordance with claim 16, wherein the constant current circuit comprises a third resistor, a first diode, a second diode, a resistance-capacitance (RC) parallel circuit, and a third transistor, and the third transistor has a third base connected to ground via the RC parallel circuit and connected to the voltage input port via the first diode and the second diode, a third emitter connected to the voltage input port via the first resistor, and a third collector connected to the third electrode of the first transistor.

18. The voltage stabilizing circuit in accordance with claim 17, wherein the third transistor is a positive-negative-positive (PNP) type transistor.

19. The voltage stabilizing circuit in accordance with claim 16, wherein each of the first capacitor unit and the second capacitor unit comprises at least one electrolytic capacitor and at least one film capacitor.

20. The voltage stabilizing circuit in accordance with claim 16, wherein the first transistor is one of a negative-positive-negative (NPN) type transistor and an N-channel Metal-Oxide-Semiconductor Field-Effect Transistor (N-MOSFET), and the second transistor is an NPN type transistor.
